(19) United States
(12) Patent Application Publication
(10) Pub. No.: US 2019/0118908 A1
(43) Pub. Date: Apr. 25, 2019

(54) SEAT-MOUNTED UMBRELLA ADAPTER AND METHOD

(71) Applicant: Clifton Hernandez, New Iberia, LA (US)

(72) Inventor: Clifton Hernandez, New Iberia, LA (US)

(21) Appl. No.: 16/128,357

(22) Filed: Sep. 11, 2018

Related U.S. Application Data
(60) Provisional application No. 62/575,261, filed on Oct. 20, 2017.

(51) Int. Cl. B63B 17/02; E04H 15/02; E04H 15/28; A47C 7/62; A47C 7/66; B63B 29/04; A01K 97/10

(52) U.S. Cl. CPC B63B 17/02; E04H 15/02; E04H 15/28; A45B 2023/0075; A47C 7/664; B63B 29/04; A01K 97/10; A47C 7/624

(57) ABSTRACT

A device for mounting an umbrella to a seat; the device includes a seat-sleeve, an umbrella-sleeve, a first-cantilever, and a second-cantilever. The seat-sleeve has a tubular sidewall and a cylindrical cavity within the sidewall. The sidewall of the seat-sleeve is constructed to allow a support of a seat, particularly a boat-seat, to pass through the seat-sleeve, in such a way that the support can slide and rotate freely within the seat-sleeve. Likewise, the umbrella-sleeve also has a tubular sidewall and a cylindrical cavity within the sidewall. The sidewall of the umbrella-sleeve is constructed to allow the shaft of an umbrella to pass through it in such a way that the shaft can slide and rotate freely within the umbrella-sleeve. The first-cantilever and the second-cantilever each are attached to both the seat-sleeve and the umbrella-sleeve, enabling the device to mount the umbrella to the boat-seat.

### CROSS-REFERENCE TO RELATED APPLICATION(S)

The present application is related to and claims priority to U.S. Provisional Patent Application No. 62/575,261 filed Oct. 20, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of canopies of existing art and more specifically relates to umbrella fixtures.

### RELATED ART

An umbrella or parasol is a folding canopy, often supported by wooden or metal ribs, which is mounted on a vertically extending pole. It is designed to protect a person against rain or sunlight. The word umbrella typically refers to a device used for protection from rain, as opposed to a parasol, which provides protection from the sun.

When fishing on a boat, excessive sunlight may cause discomfort for individuals. This may include getting sunburned or simply overheating and perspiring. Holding an umbrella to block the sunlight is not convenient while trying to fish. Fixing an umbrella in place on the boat is not sufficient due to the inability to adjust the umbrella as the sun moves. A suitable solution is desired.

U.S. Pat. No. 6,039,061 to Jeff Utley relates to a ski post-mounted boat umbrella. The described ski post-mounted boat umbrella includes a boat umbrella and a boat with a post upwardly extending therefrom. A base is provided having a rod including a pair of resilient sleeves mounted to the rod of the base via clamps in concentric relationship with respect to each other such that an axis about which the sleeves are situated resides in parallel with that of the rod. The sleeves include a first sleeve mounted at a lower end of the rod of the base and a second sleeve mounted at a central extent of the rod of the base. The rod of the base also has a threaded bore formed therein adjacent to an upper end thereof for receiving a set screw. The sleeves are designed to releasably receive the post of the boat such that the rod of the base is vertically oriented.

### SUMMARY OF THE INVENTION

In view of the foregoing disadvantages inherent in the known umbrella fixture art, the present disclosure provides a novel seat-mounted umbrella adapter and method. The general purpose of the present disclosure, which will be described subsequently in greater detail, is to provide a seat-mounted umbrella adapter and method.

A device is disclosed herein. The device includes a seat-sleeve, an umbrella-sleeve, a first-cantilever, and a second-cantilever. The seat-sleeve has a tubular sidewall and a cylindrical cavity within the sidewall. The sidewall of the seat-sleeve is constructed to allow a support of a seat, particularly a boat-seat, to pass through the seat-sleeve, in such a way that the support can slide and rotate freely within the seat-sleeve. Likewise, the umbrella-sleeve also has a tubular sidewall and a cylindrical cavity within the sidewall. The sidewall of the umbrella-sleeve is constructed to allow the shaft of an umbrella to pass through it in such a way that the shaft can slide and rotate freely within the umbrella-sleeve. The first-cantilever and the second-cantilever are each attached to both the seat-sleeve and the umbrella-sleeve, enabling the device to mount the umbrella to the boat-seat.

According to another embodiment, a method of supporting an umbrella from a seat is also disclosed herein. The method of supporting an umbrella from a seat includes providing the above described device, sliding the seat-sleeve over the mount of the boat-seat, inserting the shaft of the umbrella into the umbrella-sleeve, and swinging the device about the seat-axis into a desired position.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a seat-mounted umbrella adapter and method, constructed and operative according to the teachings of the present disclosure.

FIG. 1 is a perspective view of the device during an ‘in-use’ condition, according to an embodiment of the disclosure.

FIG. 2 is a perspective view of the device of FIG. 1, according to an embodiment of the present disclosure.

FIG. 3 is a view of umbrella-sleeve of the device of the device of FIG. 1, according to an embodiment of the present disclosure.

FIG. 4 is a perspective view of an alternative embodiment of the device of FIG. 1, according to an embodiment of the present disclosure.

FIG. 5 is a flow diagram illustrating a method of use for mounting an umbrella to a boat seat, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an umbrella fixture and more particularly to a seat-mounted umbrella adapter and method as used to improve the mounting of an umbrella to a boat seat.

Generally, the seat-mounted umbrella adapter provides a support for an umbrella that is attachable to the seat extension on a boat. The adapter is particularly designed for seats which include a vertical support below the resting surface of the seat. The adapter utilizes a tubular attachment means which merely slips over the vertical support of the seat and allows users to freely rotate the adapter and the umbrella about the seat to the desired location in order to maintain shade when fishing. Because the adapter may swing freely about the seat, users may adjust the location of the umbrella as the sun moves throughout the day, thereby ensuring that users may have protection from the sun at all angles.

The seat-mounted umbrella adapter offers users a device for efficiently supporting an umbrella on a boat. The device can be used by any fisherman or other user that has a seat with a vertical seat support. The device may be constructed of tubular connectors joined by two tubular beams, forming an H-like pattern. Preferably, in an in-use condition, the tubular connectors are oriented vertically, while the tubular beams are oriented horizontally. One tubular connector may attach to the vertical seat support, while the other may receive an umbrella. The support may be swung to adjust the location of the umbrella over the boat seat and maintain shade in the desired position. A bolt or other fastener may be passed through the umbrella connector at the bottom in order prevents the umbrella from passing completely through the connector. An adjustable, fold up version of the support may be included, as well as an umbrella. The device may also incorporate a fishing rod holder, drink holder, or other attachments and features in various embodiments. The exact specifications may vary.

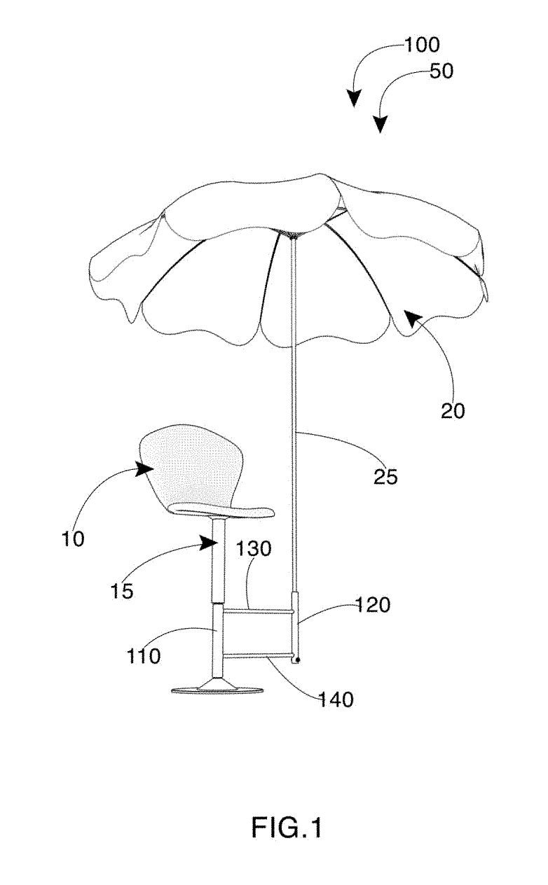

Referring now more specifically to the drawings by numerals of reference, there is shown in FIGS. 1-4, various views of a device 100.

FIG. 1 shows a device 100 during an ‘in-use’ condition 50, according to an embodiment of the present disclosure. Here, the device 100 may be beneficial for use to couple umbrella 20 having shaft 25 to boat-seat 10 having support 15. As illustrated, the device 100 may include seat-sleeve 110, umbrella-sleeve 120, first-cantilever 130, and second-cantilever 140. Seat-sleeve 110 may be able to accept support 15 of boat-seat 10, such that seat-sleeve 110 slides over and circumscribes support 15 of boat-seat 10. Seat-sleeve 110 may be sufficiently large to slide freely about support 15. Umbrella-sleeve 120 may be able to accept shaft 25 of umbrella 20, such that umbrella-sleeve 120 slides over and circumscribes shaft 25 of umbrella 20. Umbrella-sleeve 120 may be sufficiently large to slide freely about shaft 25. First-cantilever 130 may connect umbrella-sleeve 120 to seat-sleeve 110, and second-cantilever 140 may connect umbrella-sleeve 120 to seat-sleeve 110. Preferably, first-cantilever 130 and second-cantilever 140 are each rigidly coupled to both umbrella-sleeve 120 and seat-sleeve 110. First-cantilever 130 may be permanently affixed to both umbrella-sleeve 120 and seat-sleeve 110. Likewise, second-cantilever 140 may be permanently affixed to both umbrella-sleeve 120 and seat-sleeve 110. Preferably, first-cantilever 130 is parallel to second-cantilever 140. First-cantilever 130 may be affixed perpendicularly to both seat-sleeve 110 and umbrella-sleeve 120. Likewise, second-cantilever 140 is affixed perpendicularly to both seat-sleeve 110 and umbrella-sleeve 120.

Upon reading this specification, it should be appreciated that, under appropriate circumstances, considering such issues as user preferences, design preference, structural requirements, marketing preferences, cost, available materials, technological advances, etc., other structural arrangements such as, for example, alternative cantilever angles, additional mounting or retention features, auxiliary accessories, etc., may be sufficient.

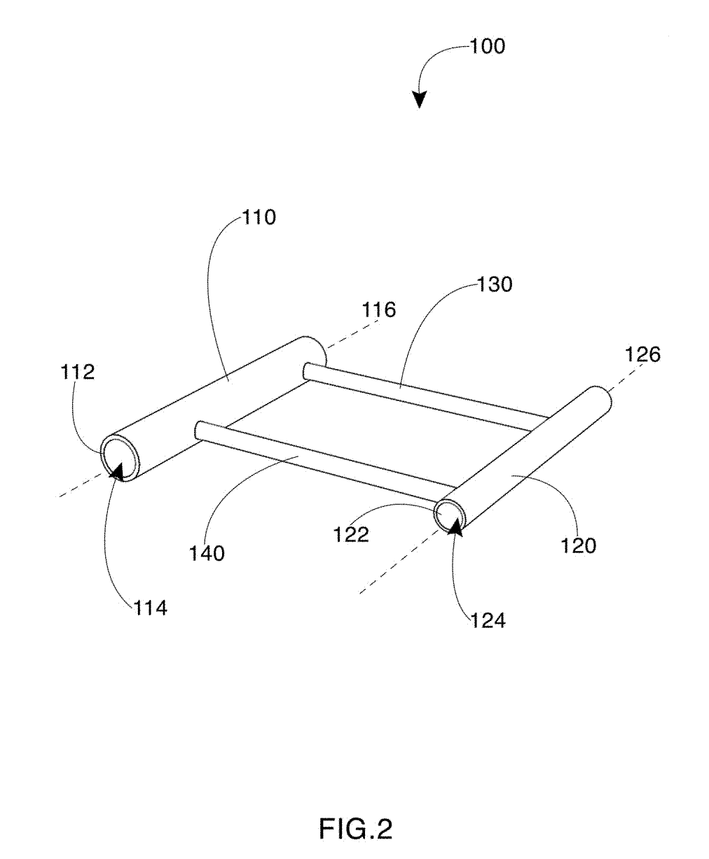

FIG. 2 shows the device 100 of FIG. 1, according to an embodiment of the present disclosure. As above, the device 100 may include seat-sleeve 110, umbrella-sleeve 120, first-cantilever 130, and second-cantilever 140. Seat-sleeve 110 may have tubular seat-sidewall 112 and cylindrical seat-cavity 114 extending along seat-axis 116. Tubular seat-sidewall 112 may be able to rotate along seat-axis 116 when installed about support 15 (FIG. 1). Umbrella-sleeve 120 may have tubular umbrella-sidewall 122 and cylindrical umbrella-cavity 124 extending along umbrella-axis 126. Tubular umbrella-sidewall 122 may be able to rotate along seat-axis 116 when installed about shaft 25 (FIG. 1). Preferably, umbrella-axis 126 and seat-axis 116 are parallel, and according, umbrella-sleeve 120 and seat-sleeve 110 are likewise parallel. In one embodiment, seat-sleeve 110, umbrella-sleeve 120, first-cantilever 130, and second-cantilever 140 are made of aluminum. In another embodiment, seat-sleeve 110, umbrella-sleeve 120, first-cantilever 130, and second-cantilever 140 are made of steel. Alternative materials may be used.

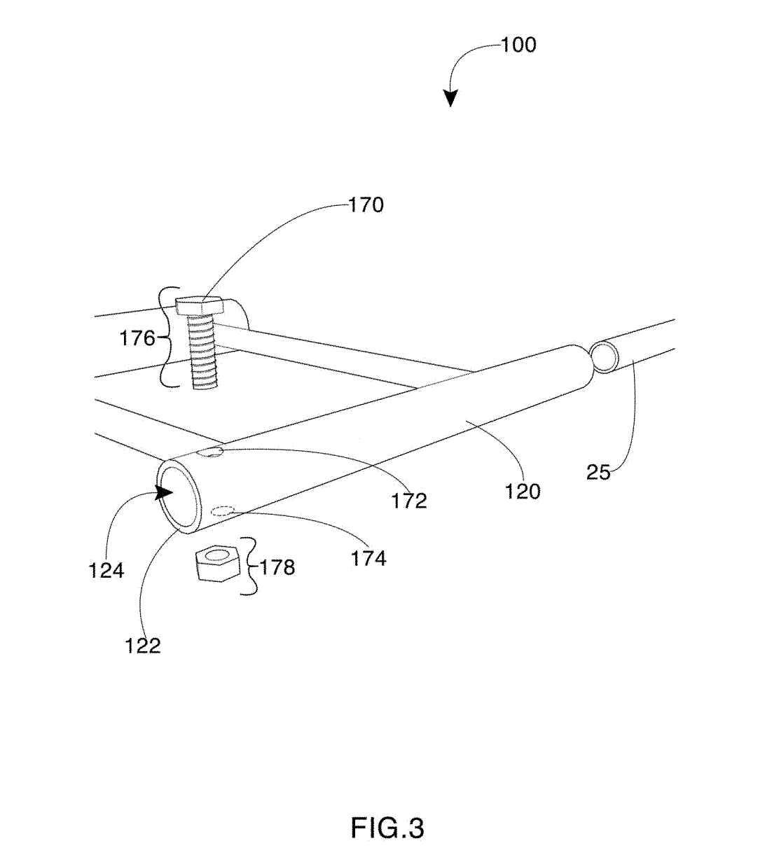

Referring now to FIG. 3, a view of umbrella-sleeve of the device 100 of FIG. 1, according to an embodiment of the present disclosure. Device 100 may further include abutment-pin 170 able to pass through umbrella-sleeve 120, such that abutment-pin 170 prevents passage of shaft 25 of past abutment-pin 170. Umbrella-sleeve 120 may further include at least one pin-aperture 172 perforating tubular umbrella-sidewall 122. At least one pin-aperture 172 may be positioned and dimensioned to receive abutment-pin 170, in such a way that abutment-pin 170 is able to pass radially through cylindrical umbrella-cavity 124. At least one pin-aperture 172 may additionally include at least one pair of pin-apertures 174. Each of at least one pair of pin-apertures 174 may mirror each other across umbrella-axis 126 (FIG. 2), enabling abutment-pin 170 to pass perpendicularly through umbrella-axis 126 (FIG. 2). Preferably, abutment-pin 170 may include bolt 176 and nut 178. Nut 178 may threadably engage bolt 176 in order to retain bolt 176 within at least one pin-aperture 172.

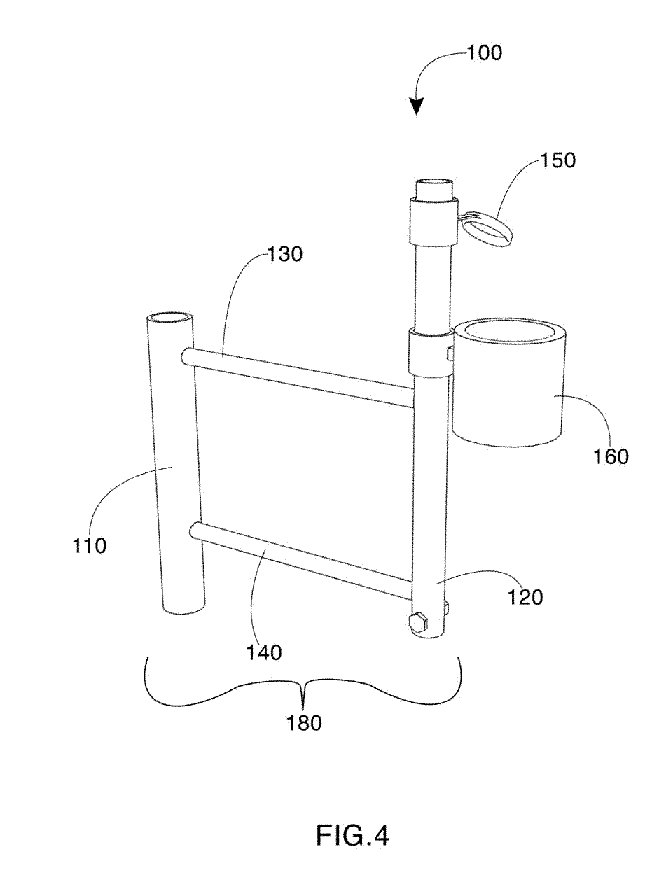

Referring now to FIG. 4 is a perspective view of an alternative embodiment of the device 100 of FIG. 1, according to an embodiment of the present disclosure. As shown, device 100 may further include fishing rod holder 150 affixed to umbrella-sleeve 120. Device 100 may also further include cup holder 160 affixed to umbrella-sleeve 120. In one embodiment, seat-sleeve 110, umbrella-sleeve 120, first-cantilever 130, and second-cantilever 140 may be welded together into unitary assembly 180.

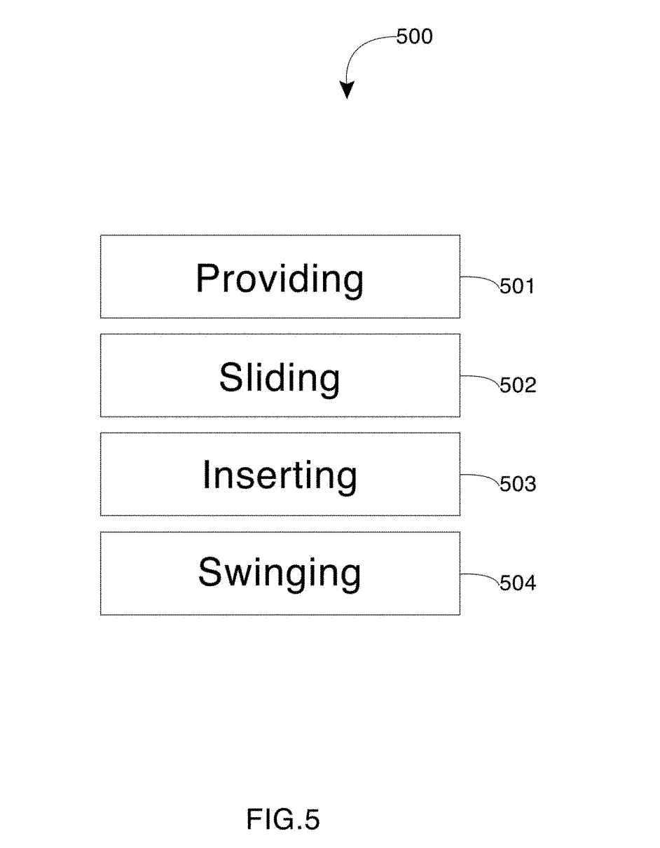

FIG. 5 is a flow diagram illustrating a method for supporting an umbrella from a seat 500, according to an embodiment of the present disclosure. In particular, the method for supporting an umbrella from a seat 500 may include one or more components or features of the method for supporting an umbrella from a seat 500 as described above. As illustrated, the method for supporting an umbrella from a seat 500 may include the steps of: step one 501, providing a device able to couple an umbrella having a shaft to a boat-seat having a support, the device comprising a seat-sleeve able to accept the support of the boat-seat, the seat-sleeve having a tubular seat-sidewall and a cylindrical seat-cavity extending along a seat-axis, the seat-sleeve being sufficiently wide to enable the support of the boat-seat to rotate freely within the seat-sleeve along the seat-axis, an umbrella-sleeve able to accept the shaft of the umbrella, the umbrella-sleeve having a tubular umbrella-sidewall and a cylindrical umbrella-cavity extending along an umbrella-axis, the umbrella-sleeve being sufficiently wide to enable the shaft of the umbrella to rotate freely within the umbrella-sleeve along the umbrella-axis, a first-cantilever connecting the umbrella-sleeve to the seat-sleeve, and a second-cantilever connecting the umbrella-sleeve to the seat-sleeve; step two 502, sliding the seat-sleeve over the mount of the boat-seat; step three 503, inserting the shaft of the umbrella into the umbrella-sleeve; and step 504, swinging the device about the seat-axis into a desired position.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for supporting an umbrella from a seat are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device able to couple an umbrella having a shaft to a boat-seat having a support, the device comprising:
a seat-sleeve able to accept the support of the boat-seat, the seat-sleeve having a tubular seat-sidewall and a cylindrical seat-cavity extending along a seat-axis, the seat-sleeve being sufficiently wide to enable the support of the boat-seat to rotate freely within the seat-sleeve along the seat-axis;
an umbrella-sleeve able to accept the shaft of the umbrella, the umbrella-sleeve having a tubular umbrella-sidewall and a cylindrical umbrella-cavity extending along an umbrella-axis, the umbrella-sleeve being sufficiently wide to enable the shaft of the umbrella to rotate freely within the umbrella-sleeve along the umbrella-axis;
a first-cantilever connecting the umbrella-sleeve to the seat-sleeve; and
a second-cantilever connecting the umbrella-sleeve to the seat-sleeve.

2. The device of claim 1, further comprising a fishing rod holder affixed to the umbrella-sleeve.

3. The device of claim 1, further comprising a cup holder affixed to the umbrella-sleeve.

4. The device of claim 1, wherein the first-cantilever is parallel to the second-cantilever.

5. The device of claim 1, wherein the first-cantilever is permanently affixed to both the umbrella-sleeve and the seat-sleeve.

6. The device of claim 1, wherein the first-cantilever is affixed perpendicularly to both the seat-sleeve and the umbrella-sleeve.

7. The device of claim 1, wherein the second-cantilever is affixed perpendicularly to both the seat-sleeve and the umbrella-sleeve.

8. The device of claim 1, wherein the second-cantilever is permanently affixed to both the umbrella-sleeve and the seat-sleeve.

9. The device of claim 1, further comprising an abutment-pin able to pass through the umbrella-sleeve, such that the abutment-pin prevents passage of the shaft of the umbrella past the abutment-pin.

10. The device of claim 9, wherein the umbrella-sleeve further includes at least one pin-aperture perforating the tubular umbrella-sidewall, the at least one pin-aperture being positioned and dimensioned to receive the abutment-pin, such that the abutment-pin is able to pass radially through the cylindrical umbrella-cavity.

11. The device of claim 10, wherein the at least one pin-aperture includes at least one pair of said pin-apertures mirroring each other across the umbrella-axis.

12. The device of claim 9, wherein the abutment-pin is a bolt and a nut.

13. The device of claim 1, wherein the umbrella-axis and the seat-axis are parallel.

14. The device of claim 1, wherein the seat-sleeve, the umbrella-sleeve, the first-cantilever, and the second-cantilever are made of aluminum.

15. The device of claim 1, wherein the seat-sleeve, the umbrella-sleeve, the first-cantilever, and the second-cantilever are made of steel.

16. The device of claim 1, wherein the seat-sleeve, the umbrella-sleeve, the first-cantilever, and the second-cantilever are welded together into a unitary assembly.

17. A seat-mounted umbrella adapter able to couple an umbrella having a shaft to a boat-seat having a support, the seat-mounted umbrella adapter comprising:
a seat-sleeve able to accept the support of the boat-seat, the seat-sleeve having a tubular seat-sidewall and a cylindrical seat-cavity extending along a seat-axis, the seat-sleeve being sufficiently wide to enable the support of the boat-seat to rotate freely within the seat-sleeve along the seat-axis;
an umbrella-sleeve able to accept the shaft of the umbrella, the umbrella-sleeve having a tubular umbrella-sidewall and a cylindrical umbrella-cavity extending along an umbrella-axis, the umbrella-sleeve being sufficiently wide to enable the shaft of the umbrella to rotate freely within the umbrella-sleeve along the umbrella-axis;
a first-cantilever connecting the umbrella-sleeve to the seat-sleeve; and
a second-cantilever connecting the umbrella-sleeve to the seat-sleeve;
wherein the first-cantilever is parallel to the second-cantilever;
wherein the first-cantilever is permanently affixed to both the umbrella-sleeve and the seat-sleeve;
wherein the second-cantilever is permanently affixed to both the umbrella-sleeve and the seat-sleeve;
wherein the first-cantilever is affixed perpendicularly to both the seat-sleeve and the umbrella-sleeve;
wherein the second-cantilever is affixed perpendicularly to both the seat-sleeve and the umbrella-sleeve;
further comprising an abutment-pin able to pass through the umbrella-sleeve, such that the abutment-pin prevents passage of the shaft of the umbrella past the abutment-pin;
wherein the umbrella-sleeve further includes at least one pin-aperture perforating the tubular umbrella-sidewall, the at least one pin-aperture being positioned and dimensioned to receive the abutment-pin, such that the abutment-pin is able to pass radially through the cylindrical umbrella-cavity;
wherein the at least one pin-aperture includes at least one pair of said pin-apertures mirroring each other across the umbrella-axis;
wherein the abutment-pin is a bolt and a nut; and
wherein the umbrella-axis and the seat-axis are parallel.

18. A method of coupling an umbrella to a boat seat, the method comprising the steps of:
providing a device able to couple an umbrella having a shaft to a boat-seat having a support, the device comprising a seat-sleeve able to accept the support of the boat-seat, the seat-sleeve having a tubular seat-sidewall and a cylindrical seat-cavity extending along a seat-axis, the seat-sleeve being sufficiently wide to enable the support of the boat-seat to rotate freely within the seat-sleeve along the seat-axis, an umbrella-sleeve able to accept the shaft of the umbrella, the umbrella-sleeve having a tubular umbrella-sidewall and a cylindrical umbrella-cavity extending along an umbrella-axis, the umbrella-sleeve being sufficiently wide to enable the shaft of the umbrella to rotate freely within the umbrella-sleeve along the umbrella-axis, a first-cantilever connecting the umbrella-sleeve to the seat-sleeve, and a second-cantilever connecting the umbrella-sleeve to the seat-sleeve;
sliding the seat-sleeve over the mount of the boat-seat;
inserting the shaft of the umbrella into the umbrella-sleeve; and
swinging the device about the seat-axis into a desired position.
